(19) United States
(12) Patent Application Publication
(10) Pub. No.: US 2016/0379733 A1
(43) Pub. Date: Dec. 29, 2016

(54) LAN CABLE WITH FOAMED POLYSULFONE INSULATION

(71) Applicant: NEXANS, Paris (FR)

(72) Inventors: Greg Heffner, Ephrata, PA (US); William Paul Mulligan, Denver, PA (US)

(21) Appl. No.: 14/753,294

(22) Filed: Jun. 29, 2015

(51) Int. Cl. H01B 3/30; H01B 7/295; H01B 3/44; H01B 11/00; H01B 11/04

(52) U.S. Cl. CPC H01B 3/301; H01B 11/002; H01B 11/04; H01B 3/443; H01B 7/295

(57) ABSTRACT

A communications cable is provided having a jacket and a plurality of twisted pair, each twisted pair having two insulated conductors twisted around one another. The insulation on the insulated twisted conductors is foamed polysulfone.

### FIELD OF THE INVENTION

The present arrangement relates to LAN cables. More particularly, the present arrangement relates to LAN cables that employ polysulfone insulation.

### BACKGROUND

Communication cables come in wide variety of shapes and sizes depending on the application. One type of communication cable is the LAN cable or Local Area Network cable common in the computer industry. Such cables typically include one or more twisted pairs of cables, one or more additional components such as separators, shields, drain wires etc . . . and a jacket around the components. LAN cables can come in many sizes based on the pair count, but for the purposes of illustration the present application, the present examples use the common 4-pair LAN cable used for network communication such as the one pictured in prior art FIG. 1 (shown with optional cross-filler).

When constructing the cables careful attention is paid to the construction of each component in order to not only maintain the desired electrical characteristics but also to meet the various mechanical and fire safety standards. For example, LAN cables need to meet certain electrical characteristics such as those set forth in the CAT 5, CAT 5e, CAT 6, etc . . . (setting for example allowable insertion loss, return loss and crosstalk requirements for 100 ohm impedance cable) based on the TIA 568C.2 industry standard.

While meeting those electrical standards, these same LAN cables also need to meet certain physical requirements such as cold bend, insulation elongation, and tensile requirements as set forth in the UL 444 industry standard.

Moreover, LAN cables also need to meet fire and smoke tests such as those outlined in NFPA 262/UL 910, UL1666 and UL1685 depending on listing type.

In order to meet these requirements, regarding the insulation used on the twisted pairs, LAN cable producers often use FEP (Fluorinated Ethylene Propylene) because it not only has excellent electrical properties but also has both good mechanical properties and fame/smoke resistance. However, FEP is expensive and it is halogenated and there is generally a desire to reduce harmful halogens in cables owing to environmental and health concerns.

In order to avoid the use of FEP some prior art solutions use fire/smoke resistant PE (Polyethylene), PP (Polypropylene), and PVC (Poly Vinyl Chloride) for the pair insulation because they are less expensive than FEP. However, these polymers require fillers and modifications to enhance their smoke/fire resistance properties that negatively affects their mechanical properties and their electrical properties are likewise not as good as FEP.

Other prior art solutions, including U.S. Patent Publication No. 2014/0262427, have used foamed non-halogenated polymers including polysulfone in LAN cables for its improved fire and smoke properties. In these solutions the polymer is foamed to improve smoke and flame spread. In this solution, in some options the polymer is polysulfone but it is employed as a separator (and not on the primary pair insulation).

### OBJECTS AND SUMMARY

The present arrangement improves on the prior art by providing a LAN cable that employs foamed polysulfone for use as insulation on the twisted pairs in LAN cable. The foamed polysulfone of the present arrangement has good fire resistance properties and simultaneously has good mechanical properties.

Polysulfone (non-foamed) is known to have good fire resistance properties but it is roughly as expensive as FEP and it tends to be stiff preventing its effective use as LAN pair insulation. The present arrangement employs a formulation for foamed polysulfone that makes it a suitable replacement for FEP as LAN pair insulation to provide comparable electrical and mechanical characteristics compared to FEP but at a lesser cost.

To this end the present arrangement provides for a communications cable having a jacket and a plurality of twisted pair, each twisted pair having two insulated conductors twisted around one another. The insulation on the insulated twisted conductors is foamed polysulfone.

### BRIEF DESCRIPTION OF THE DRAWINGS

The present invention can be best understood through the following description and accompanying drawings, wherein:

FIG. 1 illustrates a prior art LAN cable;

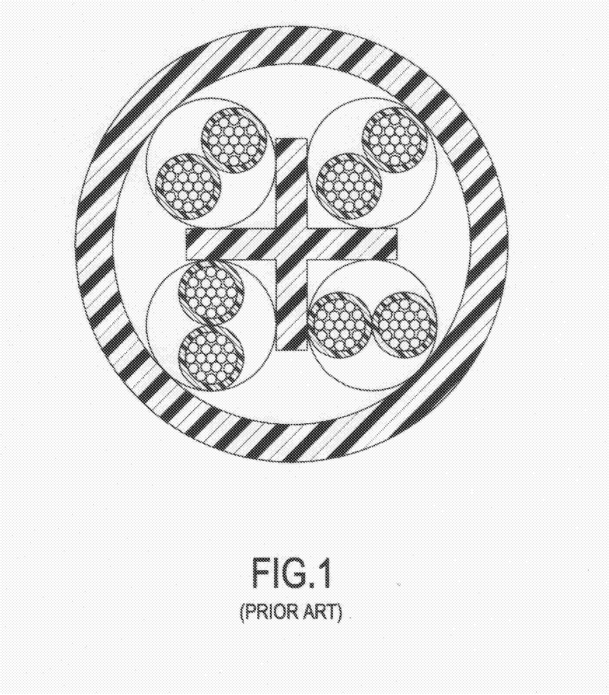

FIG. 2 illustrates a LAN cable according to one embodiment; and

FIG. 3 illustrates a LAN cable according to another embodiment.

### DETAILED DESCRIPTION

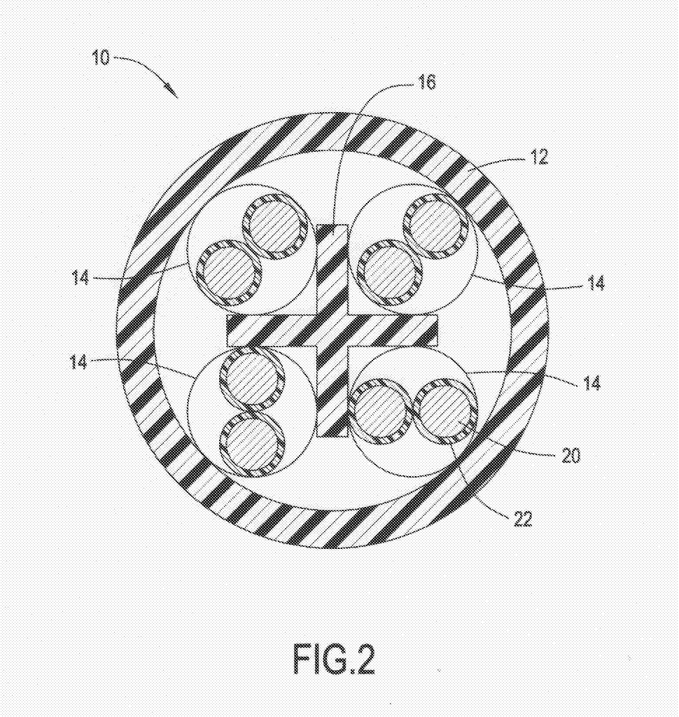

The present arrangement as illustrated for example in FIG. 2 is directed to a LAN cable 10 having a jacket 12, four twisted pairs of conductors (pairs) 14 and optional separator 16. Each of twisted pairs 14 are made from two twisted conductors 20, each of which has an insulation 22 thereon, It is understood that such components are exemplary and are in no way intended to limit the scope of the present invention. Cable 10 may have more or less than four (4) twisted pairs 14. Additionally, cable 10 may have additional components (not shown) such shielding, ground w res, binders etc . . . The construction of jacket 12 may be made from flame retardant polymers typically used in LAN cable construction such as FRPVC (Flame Retardant Poly Vinyl Chloride) or other flame retardant polyolefins.

In the present arrangement, insulation 22 on each of conductors 20 are made from foamed polysulfone. In the present example conductors 20 are preferably 24 awg to 22 awg copper conductors. Insulation 22 preferably has a thickness ranging from 0.006″ to 0.015″ and is made from a foamed polysulfone. It is noted that higher void percentages improve electrical results and reduce costs, however decrease crush resistance and increase scrap, so a balance is required for each cable design. In the present arrangement a void percentage in the foamed polysulfone of about 20% to 50% is used depending on the desired physical requirements.

Applicants note that insulation 22 differs from crossfillers such as optional cross filler/separator 16 in several ways. One of the largest differences is that the effective dielectric of insulation 22 is critical to make cable 10 perform as intended due to the proximity of insulation 22 to conductors 20. A cross filler and the material selection thereof may have some effect on the overall cable performance. However due to its location which is farther from conductors 20, the material section effect is greatly diminished.

In the present instance where insulation 22 is foamed polysulfone, the effective dielectric can be altered by changing the foaming %, the thickness of insulation 22, the shape of insulation 22, as well as additives mixed into the material. The present arrangement contemplates the use of foamed polysulfone as insulation 22 on conductors 20 with the correct balance of the above variables needed for cable 10 to achieve the performance criteria listed in TIA 568C.2 industry standard as discussed in more detail below. In addition, such factors for the dimensions and material/void % for insulation 22 are selected so survive the cabling (twisting of insulated conductors 20 into twisted pairs), including but not limited to the correct blend of foam void %, wall thickness and insulation material combinations.

In such an arrangement, when insulation 22 is foamed, it allows the reduction of the diameter of insulation 22 when compared to prior art solid insulations between 0.008″ to 0.020″ in wall thickness. This helps in several areas, including less material usage, smaller cable size, and reduced cost. In addition, by using foamed polysulfone for insulation 22, pairs 14 exhibit very good flame and smoke properties and because of this, the wall thickness of jacket 12 can likewise be reduced while still providing acceptable margins in the UL 262 flame test.

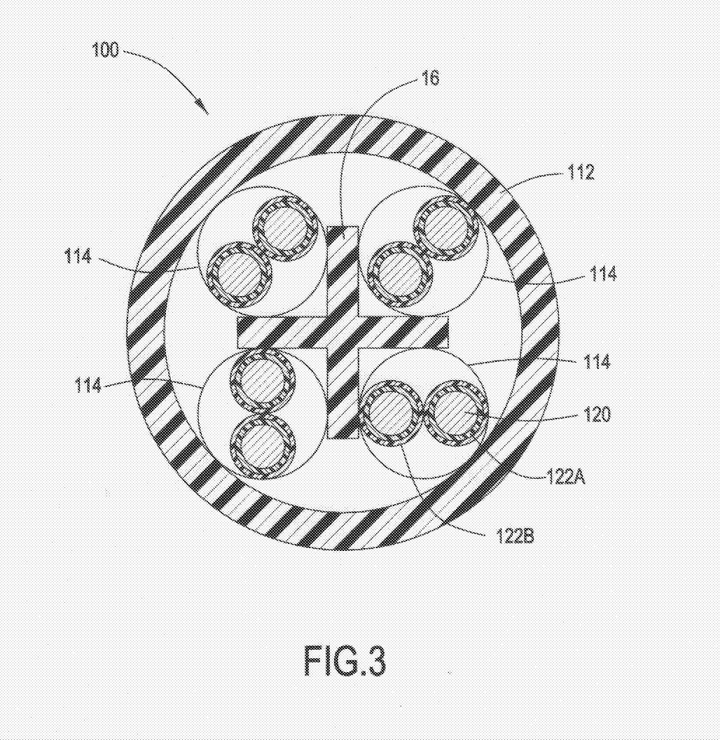

In another embodiment as shown in FIG. 3, a cable 100 is shown having a jacket 112, four twisted pairs of conductors (pairs) 114 and optional separator 116. As with FIG. 2 above, each of twisted pairs 114 are made from two twisted conductors 120, each of which has an insulation 122 thereon. However, in the arrangement of FIG. 3, insulation 122 is divided into a first inner layer 122a and a second outer layer 122b.

In a first arrangement, inner layer 122a is made from a solid PEI, PVC, Polyolefin, etc . . . material, typically a polymer which has a low dielectric constant and which is good for electrical performance and ideally with good with flame retardant properties. Outer layer 122b is then made from foamed Polysulfone (PSU).

In such an arrangement the polysulfone outer layer 122b will generally be of the same material type as in the example shown above in FIG. 2. However, it is possible that the void percentage in the foam can be increased due to inner layer 122a being used as a support structure.

In one exemplary embodiment, the thicknesses of layers 122a and 122b may depend on the cable design and electrical criteria. However, in one exemplary design, the ratio of thicknesses is 20%/80% and vice versa. Generally the thickness of inner layer 122a Is about 0.004″ to 0.008″ and the thickness of outer layer 122b is about 0.004″ to 0.008.″ Such a dual layer insulation 122a/122b should be slightly smaller than its solid counter part due to the foaming of the insulation allows a reduction in OD(outside diameter) of the cable while still achieving the same electrical results.

In the case of using polyolefins as solid material for inner layer 122a and foamed polysulfone as outer layer 122b, the polyolefin can provide good electrical properties and increased crush resistance at a low cost for inner layer 122a, without have to worry about its poor flame performance. Adding a foamed polysulfone insulation as second layer 122b serves as a barrier the fire test and thus should allow acceptable margins in both electrical and fire testing.

Moreover, two layers of insulation 122a and 122b allow the cable designer to customize cable 100 for particular applications, For example to provide good electrical properties for a cable inner layer 122a can have a low dielectric constant and dissipation factor, but does not need to have good flame resistance. In turn the flame resistance can be accomplished by outer layer 122b which in turn does not need to have good electrical properties in general, but can have good flame and smoke properties, Another advantage of this arrangement is to reduce costs. Typically materials which have good flame; smoke and electrical properties (like FEP) are very costly. Using layered insulation allows lower cost materials to be used where their benefits can be maximized.

In another embodiment, it is possible to invert the materials and use foam Polysulfone as the inner layer 122a and other material on the outer layer 122b such as the above described polyolefins.

While only certain features of the invention have been illustrated and described herein, many modifications, substitutions, changes or equivalents now occur to those skilled in the art. It is therefore, to be understood that this application is intended to cover all such modifications and changes that fall within the true spirit of the invention.

What is claimed is:

1. A communications cable, said cable comprising:
a jacket; and
a plurality of twisted pair, each twisted pair having two insulated conductors twisted around one another,
wherein an insulation on said insulated twisted conductors is foamed polysulfone.

2. The communications cable as claimed in claim 1,
wherein said jacket is a flame retardant polyeolfin jacket.

3. The communications cable as claimed in claim 1, wherein said insulation on said insulated conductors has a wall thickness between 0.006″ to 0.015.″

4. The communications cable as claimed in claim 1, wherein said insulation on said insulated conductors is foamed polysulfone with a void percentage ranging from 20% to 50%.

5. A communications cable, said cable comprising:
a jacket; and
a plurality of twisted pair, each twisted pair having two insulated conductors twisted around one another,
wherein said insulated twisted conductors are covered with two layers of insulation, a first inner layer of non-foamed polymer and a second layer of foamed polysulfone.

6. The communications cable as claimed in dam 5, wherein first layer of insulation is selected from the group consisting of solid PEI, PVC, and Polyolefin.

7. The communications cable as claimed in claim 5, wherein the thickness of said inner layer is about 0.004″ to 0.008.″

8. The communications cable as claimed in claim 5, wherein the thickness of said outer layer is about 0.004″ to 0.008.″

9. The communications cable as claimed in claim 5, wherein the ratio of thicknesses between said inner layer of insulation and said outer layer of insulation is 20%/80% and vice versa.
